(19) United States
(12) Patent Application Publication
(10) Pub. No.: US 2011/0108591 A1
(43) Pub. Date: May 12, 2011

(54) Cartop Carrier with Boat as Lid

(75) Inventor: Alex Francesco Lechich, Bronx, NY (US)

(73) Assignee: Alex Francesco Lechich, Bronx, NY (US)

(21) Appl. No.: 12/614,036

(22) Filed: Nov. 6, 2009

(51) Int. Cl. B60R 9/00; B63B 1/00

(52) U.S. Cl. 224/486; 114/343

(57) ABSTRACT

The invention is a cartop cargo carrier in the form typically and commonly seen in the art today, with the exception that the lid doubles as a one-piece boat. The boat/lid is constructed of molded plastic/polymer as is known in the art and commonly available and used today for small sized boats (6-12 feet typically), and is similar in materials as is known in the art of cartop cargo carriers. The boat/lid is constructed of a heavier gauge than the portion typically forming the bottom section (and indeed the overall units) of these carriers, to enhance it's suitability and safety for use as a small boat for one or two persons. As part of the construction of the boat/lid, folding seat(s) and oars and retractable oarlocks are fastened to the inside of boat. Also, in the larger model, a reinforced transom is included to accommodate a small electric or gasoline outboard motor.

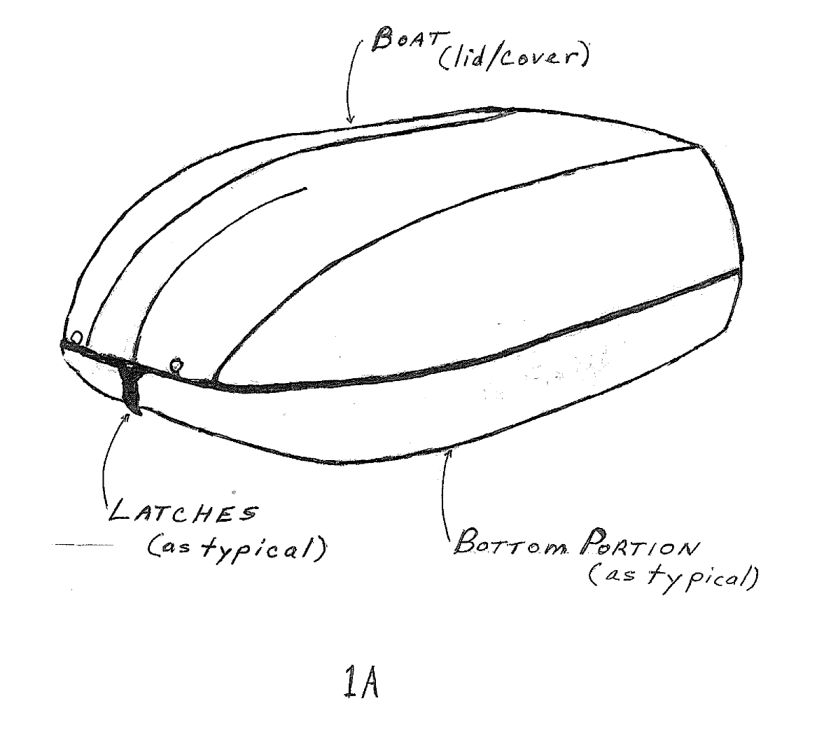

### CROSS-REFERENCE OR RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

There have been patents issued, as recently as the mid 1980's, for cartop boats that either fold together by hinges (U.S. Pat. No. 4,841,900), or can be attached in sections (U.S. Pat. No. 4,052,761), and encompass, when not assembled as a boat, an apparatus that can be used as a cartop cargo (trunk, luggage) carrier. These two and other similar ones were intended to be mainly a boat, with the added feature of having the capability of being used also as a cartop carrier. In those days cartop cargo carriers were relatively not widely available or used, since they were mainly home-made or boxy conversions of travel bags, and the newer type aerodynamic plastic composites had not been developed.

Today these units are quite common and used for a variety of purposes, mainly to store larger items during travel or vacation (as in the past), but many are now kept on cars permanently or semi-permanently. This is partly due to their light weight and good aerodynamics. Both of these characteristics also lend well to the ability for them (the lid precisely) to be used as boats because of their light weight and correspondingly (to aerodynamics), their potentially good hydrodynamic properties. It is in fact the similarity in shape of the lids or tops of modern cartop carriers to the shape of an overturned boat that first gave the inventor this idea.

The past inventions mentioned above were meant to be primarily boats, and the various contrivances were designed to optimize the features of the boat, mainly to make it large enough to fit the then commonly considered size needs of a usable boat. These have to be assembled together in some form, which can be quite impractical and time consuming (the inventor has owned several folding boats, which were both difficult to assemble). The smallest dinghy (a tender for a larger boat) was then typically eight feet long. More recently, due partially to the establishment of light and strong molded plastic polymers for small boats, dinghy sizes have come down to six or seven feet (although larger ones are of course still available). These smaller boats are often used as a dinghy, or just as light recreation on near-shore and other calm waters. The ability to get out on the water practically and easily, wherever you happen to be, is a very desirable and valuable add-on for a cartop cargo box. The invention is light enough to be carried by one person, yet sturdy and seaworthy enough to be used as a dinghy or for light recreation for one or two persons (the latter typically in the larger size).

The intended use of the invention is for use as an easily-deployed dinghy or light water recreation. Owners of larger boats that are moored away from shore require a launch service provided by a marina, or a shore-based dinghy to get them to their vessels and back. Many of these owners prefer having their own dinghy for the independence it offers over a launch service (which is not always available, or is sporadic or slow). Keeping their own dinghies along the shore is often difficult or undesirable due to several factors including restricted access or the threat of larceny or vandalism. The ability to bring their own light dinghies each time can be very desirable, especially if it can be done easily and practically. Another broad type of use for the invention is for easy and practical light water recreation. Many people utilize cartop cargo boxes for vacations, whether for camping or on other outdoor-associated trips including to hotels, bed & breakfasts and spas located near water bodies. Upon arrival at these destinations, the invention can be easily deployed from wherever there is water access from an automobile. The stored contents of the carrier can either be left temporarily uncovered (i.e., at a campsite), or removed to another location including into the lodging, the car or other shelter as is typical upon arrival at such a destination. Having the choice of either leaving the carrier as is, or having the ability to deploy a small boat wherever the owner chooses, is a very desirable option for owners of these cartop carriers. With very little difference in appearance, weight, aerodynamics or other physical characteristic, and with comparatively little projected increase in cost, a cartop carrier having the abilities of this invention has a vastly increased range of uses versus a standard single-use cartop carrier.

### BRIEF SUMMARY OF THE INVENTION

The invention is a cartop cargo carrier in the form typically and commonly seen in the art today, with the exception that the lid doubles as a one-piece boat. The boat/lid is constructed of molded plastic/polymer as is known in the art and commonly available and used today for small sized boats (6-12 feet typically), and is similar in materials as is known in the art of cartop cargo carriers. The boat/lid is constructed of a heavier gauge than the portion typically forming the bottom section (and indeed the overall units) of these carriers, to enhance it's suitability and safety for use as a small boat for one or two persons. As part of the construction of the boat/lid, folding seat(s) and oars and retractable oarlocks are fastened to the inside of boat. Also, in the larger model, a reinforced transom is included to accommodate a small electric or gasoline outboard motor.

### BRIEF DESCRIPTION OF THE SEVERAL VIEWS OF THE DRAWINGS

Being a relatively simple (but far-reaching) modification of the dual existing arts of cartop carriers and small boats (both being constructed of similar molded poly/plastic composite compounds), only one front/angle view is deemed necessary to adequately depict the invention. In the view included (1A), the drawing depicts a standard type high-capacity carrier (with a higher lid than most typical carriers, though currently available). This higher profile allows for the lid, when used as a boat, to have a freeboard of at least 10 inches in both the six and seven foot versions. This is a sufficient freeboard for boats of this size, from safety and practicality standpoints. As noted in the Detailed Description below, there are several internal modifications to the lid in the invention that are standard technologies in the small boat art. These are not shown in the drawing and unnecessary to depict as they are well known in the art and the technologies readily available; including seats and their associated hinges and attachments, oarlocks with clips, clamps or clips for oars and the oars, and in the seven foot boat a reinforced transom.

### DETAILED DESCRIPTION OF THE INVENTION

The invention is a new utility for a standard cartop cargo carrier in the form typically and commonly seen today, with the exception that the lid doubles as a one-piece boat. The units would be available in two length sizes, approximately six (6) feet and seven (7) feet, with widths of approximately four (4) feet, and freeboard (height) of approximately one (1) foot. These are the minimum sizes currently used today for dinghies and small boats, and are the maximum length sizes typically used today for cartop cargo carriers.

Typically, the interior of these units are without compartments, and have a soft inside lining the bottom such as foam or equivalent for placement of various kinds of (usually large) items. The bottom portion of the invention is generally similar to any of these typical and currently available carriers, since the invention is not dependent on significant modification of this portion. It is the boat/lid of the unit that is the invention. This portion is typically of heavier gauge material than the bottom portion, but composed of the same material (typically a poly/plastic composite as is well known in the art). It has bench-type seat(s) (one or two, according to two boat sizes described above, and made of marine plywood or composites) that can fold up into the roof (which is the floor of the boat when used as such), held by fasteners. Alternatively, the seat(s) slide into plastic-walled channels the thickness and width of the seat and fastened to the side of the boat. In this variation, the seat support folds up into the seat and the seat(s) lay inside the carrier bottom or attached along the sides of the top portion when in storage. Both of these alternatives are well known in the art and require no additional specification. The seats in the 7 foot boat are located at the center and near the aft (rear), while there is one seat at the center in the 6 foot boat. In addition, oars (strong plastic or aluminum and in two sections) are fastened to both sides inside of the boat/lid. Folding oarlocks are also included in similar fashion as is used commonly in boats, which fold down, and in the invention are fastened up against the side when the boat is inverted as a lid. In addition, in the larger (7 ft.) size a reinforced transom of marine plywood is constructed at the stern (which is also the rear end of the unit) to accommodate a small electric or gasoline outboard engine.

The fasteners holding the boat/lid to the bottom portion of the unit are known in the art and there is little or no modification necessary or additional specification to this area of the boat/lid. Similarly, other fasteners, clips and clamps already known in the art as noted above are utilized for holding the seats, oars and oarlocks. Since most units currently produced have lids that swivel up rather than being removed entirely (as in the invention) the fasteners for one side of the lid (boat) will need to accommodate this action, but these too are obviously readily known in the art (and in fact can be similar to those on the side that lock and can be lifted up).

The foregoing is considered as merely illustrative and exemplary of the principles of the invention. Further, since numerous modifications and changes will readily occur to those skilled in the art, it is not desired to limit the invention to the exact construction described, and accordingly, all suitable modifications and equivalents may be resorted to, falling within the spirit and scope of the invention.

What is claimed is:

1. A new way of making and using a cartop cargo carrier by incorporating a lid that also serves as a small boat. Although there have been inventions (as described in the specification) that allows a folding boat or one that can be put together in sections to also serve as a cartop carrier, this is the first time (to the inventor's knowledge) that the carrier actually incorporates a whole, almost fully assembled (except for seats if desired) boat.

2. The invention is the first one that uses the design characteristics and materials of modern cartop carriers. It utilizes, for the first time, the aerodynamic shape of modern carriers as the basis for the hydrodynamic shape necessary for an efficient boat hull. The light and strong composites used in modern cartop carriers also match well with modern small boat construction.
